(19) United States
(12) Patent Application Publication
(10) Pub. No.: US 2026/0222867 A1
(43) Pub. Date: Jul. 30, 2026

(54) UE and Network Nodes for Handling Radio Link Failure in a Communications System

(71) Applicant: TELEFONAKTIEBOLAGET LM ERICSSON (PUBL), Stockholm (SE)

(72) Inventors: Ali Parichehrehteroujeni, Linköping (SE); Per Elmdahl, Linköping (SE); Julien Muller, Rennes (FR); Pradeepa Ramachandra, Linköping (SE)

(21) Appl. No.: 19/144,811

(22) PCT Filed: Feb. 7, 2024
(86) PCT No.: PCT/SE2024/050111

§ 371 Date: Jun. 30, 2025

Related U.S. Application Data
(60) Provisional application No. 63/485,270, filed on Feb. 16, 2023.

(51) Int. Cl. H04W 24/10

(52) U.S. Cl. CPC H04W 24/10

(57) ABSTRACT

The present disclosure relates to a method performed by a User Equipment, UE, (105) for handling Radio Link Failure, RLF, in a communications system (100). The UE (105) determines that an RLF has occurred. The UE (105) determines whether or not a condition related to the determined RLF is fulfilled. When the condition is fulfilled, the UE (105) generates an RLF report comprising Radio Link Monitoring, RLM, information. The UE (105) provides the RLF report comprising the RLM information to a network node (101).

### TECHNICAL FIELD

The present disclosure relates generally to a User Equipment (UE), a method performed by the UE, a first network node, a method performed by the first network node. More particularly, the present disclosure relates to handling Radio Link Failure (RLF) in a communications system. The present disclosure relates to improving efficiency in RLF reporting.

### BACKGROUND

### Self-Organizing Networks (SON) in 3GPP

A Self-Organizing Network (SON) is an automation technology designed to make the planning, configuration, management, optimization and healing of mobile radio access networks simpler and faster. SON functionality and behavior has been defined and specified in generally accepted mobile industry recommendations produced by organizations such as 3rd Generation Partnership Project (3GPP) and the Next Generation Mobile Networks (NGMN).

In 3GPP, the processes within the SON area are classified into Self-configuration process and Self-optimization process. Self-configuration process is the process where newly deployed network nodes are configured by automatic installation procedures to get the necessary basic configuration for system operation. This process works in pre-operational state. Pre-operational state is understood as the state from when the network node, e.g. the evolved Node B (eNB), is powered up and has backbone connectivity until the Radio Frequency (RF) transmitter is switched on.

FIG. 1 is a block diagram illustrating ramifications of the self-configuration/self-optimization functionality. FIG. 1 is from 3GPP TS 36.300, FIGS. 22.1-1.

As illustrated in FIG. 1, functions handled in the pre-operational state like basic setup and initial radio configuration are covered by the Self Configuration process.

The self-optimization process is defined as the process where the UE and the network node measurements and performance measurements are used to auto-tune the network. This process works in operational state. Operational state is understood as the state where the RF interface is switched on.

As described in FIG. 1, functions handled in the operational state, like optimization and/or adaptation are covered by the Self Optimization process.

As seen in the top of FIG. 1, at the start of the method, the network node, e.g. the eNB, power is on and/or the network node is connected to the transport network infrastructure. In step (A), a basic setup is performed. The basic setup may comprise one or more of the following substeps:
a-1: Configuration of IP address and detection of Operations Administration Maintenance (OAM)
a-2: Authentication of network node/network (NW)
a-3: Association to a Gateway (GW)
a-4: Downloading of network node software and operational parameters.
. . . as well as further sub steps below a-4.

In step (B), initial radio configuration is performed. Step (B) may comprise one or more of the following substeps:
b-1: Neighbour list configuration
b-2: Coverage and/or capacity related parameter configuration.
. . . as well as further substeps below b2.

In step (C), optimization and/or adaptation is performed. Step (C) may comprise one or more of the following substeps:
c-1: Neighbour list optimization.
c-2: Coverage and capacity control.
. . . as well as further substeps.

Steps (A) and (B) may be a self-configuration state and may be referred to as a pre-operational state. Step (C) may be a self-optimization state and may be referred to as an operational state. Steps (A) and (B) may be performed once, and step (C) may be performed multiple times, i.e., it may be repeated.

In LTE, support for Self-Configuration and Self-Optimisation is specified, including features such as Dynamic configuration, Automatic Neighbour Relation (ANR), Mobility load balancing, Mobility Robustness Optimization (MRO), RACH optimization and support for energy saving.

In New Radio (NR), support for Self-Configuration and Self-Optimisation is specified as well, starting with Self-Configuration features such as Dynamic configuration, Automatic Neighbour Relation (ANR in Rel-15. In NR Rel-16, more SON features are being specified for, including Self-Optimisation features such as Mobility Robustness Optimization (MRO.

### Radio Link Monitoring (RLM)

In connected mode, the network typically configures the UE to perform and report Radio Resource Management (RRM) measurements to assist network-controlled mobility decisions, which may comprise, for example, handovers that are network controlled. A handover occurs when the network decides to hand over the UE from one cell to another. As a fallback, in case a handover does not work properly, a failure detection and counteraction at the UE has been specified. This is called RLF handling and is described below.

The RLF procedure is typically triggered when something unexpected happens in any of the mobility related procedures. That is detected thanks to interactions between Radio Resource Control (RRC) and lower layer protocols such as Layer 1 (L1), Medium Access Control (MAC), Radio Link Control (RLC), etc. In the case of L1, a procedure called RLM has been introduced.

### RLF-TimersAndConstants

The Information Element (IE) RLF-TimersAndConstants is used to configure UE specific timers and constants, as shown below.

### RLF-TimersAndConstants Information Element

-- ASN1START
-- TAG-RLF-TIMERSANDCONSTANTS-START

| | |
|---|---|
| RLF-TimersAndConstants ::= | SEQUENCE { |
| t310 | ENUMERATED {ms0, ms50, ms100, |

ms200, ms500, ms1000, ms2000, ms4000, ms 6000},

| | |
|---|---|
| n310 | ENUMERATED {n1, n2, n3, n4, n6, |

n8, n10, n20},

| | |
|---|---|
| n311 | ENUMERATED {n1, n2, n3, n4, n5, |

```
n6, n8, n10},
  ...,
  [[
```

| | |
|---|---|
| n311 | ENUMERATED {ms1000, ms3000, |

ms 5000, ms10000, ms15000, ms20000, ms30000}
]]
}
-- TAG-RLF-TIMERSANDCONSTANTS-STOP
-- ASN1STOP

RLF-TimersAndConstants field descriptions

n3xy
Constants are described in clause 7.3. Value n1 corresponds to 1,
value n2 corresponds to 2 and so on.
t3xy
Timers are described in clause 7.1. Value ms0 corresponds to 0
ms, value ms50 corresponds to 50 ms and so on.

| Timer | Start | Stop | At expiry |
|---|---|---|---|
| T301 | Transmission | Reception of | Go to RRC_IDLE |
| | of RRCConnection | RRCConnectionReestablishment or | |
| | ReestabilshmentRequest | RRCConnectionReestablishmentReject | |
| | | message as well as when the selected cell | |
| | | becomes unsuitable | |
| T310 | Upon | Upon receiving N311 | If security is not activated: go |
| | detecting physical layer | consecutive in-sync indications from lower | to RRC_IDLE else: initiate the |
| | problems for the PCell | layers for the PCell, upon triggering the | connection re-establishment procedure |
| | i.e. upon receiving N310 | handover procedure and upon initiating | |
| | consecutive out-of-sync | the connection re-establishment | |
| | indications from lower | procedure | |
| | layers | | |
| T311 | Upon initiating | Selection of a suitable E-UTRA | Enter RRC_IDLE |
| | the RRC connection re- | cell or a cell using another RAT. | |
| | establishment procedure | | |
| T313 | Upon | Upon receiving N314 | Inform E-UTRAN about the |
| | detecting physical layer | consecutive in-sync indications from lower | SCG radio link failure by initiating the |
| | problems for the PSCell | layers for the PSCell, upon initiating the | SCG failure information procedure as |
| | i.e. upon receiving N313 | connection re-establishment procedure, | specified in 5.6.13. |
| | consecutive out-of-sync | upon SCG release and upon receiving | |
| | indications from lower | RRCConnectionReconfiguration including | |
| | layers | MobilityControlInfoSCG | |

| Constant | Usage |
|---|---|
| N310 | Maximum number of consecutive “out-of-sync” indications for the PCell received from lower layers |
| N311 | Maximum number of consecutive “in-sync” indications for the PCell received from lower layers |
| N313 | Maximum number of consecutive “out-of-sync” indications for the PSCell received from lower |
| | layers |
| N314 | Maximum number of consecutive “in-sync” indications for the PSCell received from lower layers |

When Discontinuous Reception (DRX) is in use, in order to enable sufficient UE power saving the out-of-sync and in-sync evaluation periods are extended and depend upon the configured DRX cycle length. The UE starts in-sync evaluation whenever out-of-sync occurs. Therefore, the same period, e.g. TEvaluate_Qout_DRX, is used for the evaluation of out-of-sync and in-sync. However, upon starting the RLF timer, e.g. T310, until its expiry, the in-sync evaluation period is shortened to 100 ms, which is the same as without DRX. If the timer T310 is stopped due to N311 consecutive in-sync indications, the UE performs in-sync evaluation according to the DRX based period, e.g. TEvaluate_Qout_DRX.

The whole methodology used for RLM in Long Term Evolution (LTE), i.e. measuring the Cell-specific Reference Signal (CRS) to estimate the Physical Downlink Control Channel (PDCCH) quality, relies on the fact that the UE is connected to an LTE cell which is the single connectivity entity transmitting PDCCH and CRSs.

In summary, RLM in LTE has been specified so that the network does not need to configure any parameter. For example, the UE generates in-sync/out-of-sync (IS/OOS) events internally from lower to higher layers to control the detection of radio link problems. On the other hand, RLF/Secondary Cell Group (SCG) Failure procedures are controlled by RRC and configured by the network via counters such as for example N310, N311, N313, N314, which work as filters to avoid too early RLF triggering, and timers such as for example T310, T311, T313 and T314.

With regard to RLM and the L1 input to the RLF function, the purpose of the RLM function in the UE is to monitor the downlink radio link quality of the serving cell in RRC_CONNECTED state and is based on the CRSs, which are always associated to a given LTE cell and derived from the Physical Cell Identifier (PCI). This in turn enables the UE when in RRC_CONNECTED state to determine whether it is IS or OOS with respect to its serving cell.

The UE's estimate of the downlink radio link quality is compared with OOS and IS thresholds, e.g. Qout and Qin, respectively, for the purpose of RLM. These thresholds are expressed in terms of the Block Error Rate (BLER) of a hypothetical PDCCH transmission from the serving cell. Specifically, Qout corresponds to a 10% BLER while Qin corresponds to a 2% BLER. The same threshold levels are applicable with and without DRX.

### MRO in 3GPP

Seamless handovers are a key feature of 3GPP technologies. Successful handovers ensure that the UE moves around in the coverage area of different cells without causing too much interruptions in the data transmission. However, there will be scenarios when the network fails to handover the UE to the correct neighbor cell in time and in such scenarios the UE will declare the RLF or Handover Failure (HOF).

Upon HOF and RLF, the UE may take autonomous actions i.e. trying to select a cell and initiate a reestablishment procedure so that the UE is trying to get back as soon as it can, so that it can be reachable again. The RLF will cause a poor user experience as the RLF is declared by the UE only when it realizes that there is no reliable communication channel, e.g. radio link, available between itself and the network. Also, reestablishing the connection requires signaling with the newly selected cell, e.g. random access procedure, RRC Reestablishment Request, RRC Reestablishment RRC Reestablishment Complete, RRC Reconfiguration and RRC Reconfiguration Complete, and adds some latency, until the UE can exchange data with the network again.

There may be several possible causes for the radio link failure according to the NR specification. Causes related to the source cell could for example be expiry of the radio link monitoring related timer, e.g. T310, or the expiry of the measurement reporting associated timer, e.g. T312, not receiving the handover command from the network within this timer's duration despite sending the measurement report when T310 was running. Examples of these failures comprise reaching the maximum number of RLC retransmissions; upon receiving random access problem indication from the MAC entity; upon declaring consistent Listen Before Talk (LBT) failures in the SpCell operating in the unlicensed spectrum; upon failing the beam failure recovery procedure.

For the target cell, the HOF is due to the expiry of the T304 timer while performing a handover to the target cell.

As RLF and HOF lead to reestablishment which degrades performance and user experience, it is in the interest of the network to understand the reasons for RLF and try to optimize mobility related parameters, e.g. trigger conditions of measurement reports, to avoid later RLFs. Before the standardization of MRO related report handling in the network, only the UE was aware of some information associated with how the radio quality looked like at the time of RLF, what is the actual reason for declaring RLF etc. For the network to identify the reason for the RLF, the network needs information, both from the UE and also from the neighboring base stations.

After an RLF is declared, the RLF report is logged and included in the VarRLF-Report variable and, once the UE selects a cell and succeeds with a reestablishment, it includes in the RRC Reestablishment Complete message an indication that it has an RLF report available, to make the target cell aware of that availability. Then, upon receiving an UEInformationRequest message with a flag “rlf-ReportReq-r9” set, the UE shall include the RLF report, e.g. stored in a UE variable VarRLF-Report, as described above, in an UEInformationResponse message and send to the network.

The content of the RLF report specified in Rel-17 of the RRC specification is shown in the following:

| | |
|---|---|
| RLF-Report-r16 ::= | CHOICE { |
| nr-RLF-Report-r16 | SEQUENCE { |
| measResultLastServCell-r16 | MeasResultRLFNR-r16, |
| measResultNeighCells-r16 | SEQUENCE { |
| measResultListNR-r16 | MeasResultList2NR-r16 |

OPTIONAL,

| | |
|---|---|
| measResultListEUTRA-r16 | MeasResultList2EUTRA- |

| | |
|---|---|
| r16 | OPTIONAL |

| | |
|---|---|
| } | OPTIONAL, |
| c-RNTI-r16 | RNTI-Value, |
| previousPCellId-r16 | CHOICE { |
| nrPreviousCell-r16 | CGI-Info-Logging-r16, |
| eutraPreviousCell-r16 | CGI-InfoEUTRALogging |

}
OPTIONAL,

| | |
|---|---|
| failedPCellId-r16 | CHOICE { |
| nrFailedPCellId-r16 | CHOICE { |
| cellGlobalId-r16 | CGI - Info-Logging- |

r16,

| | |
|---|---|
| pci-arfcn-r16 | PCI-ARFCN-NR-r16 |

},

| | |
|---|---|
| eutraFailedPCellId-r16 | CHOICE { |
| cellGlobalId-r16 | CGI-InfoEUTRALogging, |
| pci-arfcn-r16 | PCI-ARFCN-EUTRA-r16 |

```
      }
    },
```

| | |
|---|---|
| reconnectCellId-r16 | CHOICE { |
| nrReconnectCellId-r16 | CGI-Info-Logging-r16, |
| eutraReconnectCellId-r16 | CGI-InfoEUTRALogging |

}
OPTIONAL,

| | |
|---|---|
| timeUntilReconnection-r16 | TimeUntilReconnection-r16 |

OPTIONAL,

| | |
|---|---|
| reestablishmentCellId-r16 | CGI-Info-Logging-r16 |

OPTIONAL,

| | |
|---|---|
| timeConnFailure-r16 | INTEGER (0..1023) |

OPTIONAL,

| | |
|---|---|
| timeSinceFailure-r16 | TimeSinceFailure-r16, |
| connectionFailureType-r16 | ENUMERATED {rlf, hof}, |
| rlf-Cause-r16 | ENUMERATED {t310-Expiry, |

randomAccessProblem, rlc-MaxNumRetx,
beamFailureRecoveryFailure, lbtFailure-r16,

bh-

rlfRecoveryFailure, t312-expiry-r17, spare1},

| | |
|---|---|
| locationInfo-r16 | LocationInfo-r16 |

OPTIONAL,

| | |
|---|---|
| noSuitableCellFound-r16 | ENUMERATED {true} |

OPTIONAL,

| | |
|---|---|
| ra-InformationCommon-r16 | RA-InformationCommon-r16 |

```
OPTIONAL,
    ...,
    [[
```

| | |
|---|---|
| csi-rsRLMConfigBitmap-v1650 | BIT STRING (SIZE (96)) |

```
OPTIONAL
    ]],
    [[
```

| | |
|---|---|
| lastHO-Type-r17 | ENUMERATED {cho, daps, |

| | |
|---|---|
| spare2, spare1} | OPTIONAL, |

| | |
|---|---|
| timeConnSourceDAPS-Failure-r17 | TimeConnSourceDAPS-Failure- |

| | |
|---|---|
| r17 | OPTIONAL, |

| | |
|---|---|
| timeSinceCHO-Reconfig-r17 | TimeSinceCHO-Reconfig-r17 |

OPTIONAL,

| | |
|---|---|
| choCellId-r17 | CHOICE { |
| cellGlobalId-r17 | CGI-Info-Logging-r16, |
| pci-arfcn-r17 | PCI-ARFCN-NR-r16 |

}
OPTIONAL,

| | |
|---|---|
| choCandidateCellList-r17 | ChoCandidateCellList-r17 |

```
OPTIONAL
    ]]
  },
```

| | |
|---|---|
| eutra-RLF-Report-r16 | SEQUENCE { |
| failedPCellId-EUTRA | CGI-InfoEUTRALogging, |
| measResult-RLF-Report-EUTRA-r16 | OCTET STRING, |

```
    ...,
    [[
```

| | |
|---|---|
| measResult-RLF-Report-EUTRA-v1690 | OCTET STRING |

```
OPTIONAL
    ]]
  }
}
```

| | |
|---|---|
| SuccessHO-Report-r17 ::= | SEQUENCE { |
| sourceCellInfo-r17 | SEQUENCE { |
| sourceCellId-r17 | CGI-Info-Logging-r16, |
| sourceCellMeas-r17 | MeasResultSuccessHONR- |

| | |
|---|---|
| r17 | OPTIONAL, |

| | |
|---|---|
| rlf-InSourceDAPS-r17 | ENUMERATED {true} |

OPTIONAL
},

| | |
|---|---|
| targetCellInfo-r17 | SEQUENCE { |
| targetPCellId-r17 | CGI-Info-Logging-r16, |
| targetCellMeas-117 | MeasResultSuccessHONR- |

| | |
|---|---|
| r17 | OPTIONAL |

},

| | |
|---|---|
| measResultNeighCells-r17 | SEQUENCE { |
| measResultListNR-r17 | MeasResultList2NR-r16 |

OPTIONAL,

| | |
|---|---|
| measResultListEUTRA-r17 | MeasResultList2EUTRA- |

| | |
|---|---|
| r16 | OPTIONAL |

}
OPTIONAL,

| | |
|---|---|
| locationInfo-r17 | LocationInfo-r16 |

OPTIONAL,

| | |
|---|---|
| timeSinceCHO-Reconfig-r17 | TimeSinceCHO-Reconfig-r17 |

OPTIONAL,

| | |
|---|---|
| shr-Cause-r17 | SHR-Cause-r17 |

OPTIONAL,

| | |
|---|---|
| ra-InformationCommon-r17 | RA-InformationCommon-r16 |

OPTIONAL,

| | |
|---|---|
| upInterruptionTimeAtHO-r17 | UPInterruptionTimeAtHO-r17 |

OPTIONAL,

| | |
|---|---|
| c-RNTI-r17 | RNTI -Value |

OPTIONAL,
...
}

| | |
|---|---|
| MeasResultList2NR-r16 ::= | SEQUENCE (SIZE (1..maxFreq)) OF |

MeasResult2NR-r16

| | |
|---|---|
| MeasResultList2EUTRA-r16 ::= | SEQUENCE (SIZE (1..maxFreq)) OF |

MeasResult2EUTRA-r16

| | |
|---|---|
| MeasResult2NR-r16 ::= | SEQUENCE { |
| ssbFrequency-r16 | ARFCN-ValueNR |

OPTIONAL,

| | |
|---|---|
| refFreqCSI-RS-r16 | ARFCN-ValueNR |

OPTIONAL,

| | |
|---|---|
| measResultList-r16 | MeasResultListNR |

}

| | |
|---|---|
| MeasResultListLogging2NR-r16 ::= | SEQUENCE (SIZE (1..maxFreq)) OF |

MeasResultLogging2NR-r16

| | |
|---|---|
| MeasResultLogging2NR-r16 ::= | SEQUENCE { |
| carrierFreq-r16 | ARFCN-ValueNR, |
| measResultListLoggingNR-r16 | MeasResultListLoggingNR-r16 |

}

| | |
|---|---|
| MeasResultListLoggingNR-r16 ::= | SEQUENCE (SIZE (1..maxCell Report)) |

OF MeasResultLoggingNR-r16

| | |
|---|---|
| MeasResultLoggingNR-r16 ::= | SEQUENCE { |
| physCellId-r16 | PhysCellId, |
| resultsSSB-Cell-r16 | MeasQuantityResults, |
| numberOfGoodSSB-r16 | INTEGER (1..maxNrofSSBs-r16) |

OPTIONAL
}

| | |
|---|---|
| MeasResult2EUTRA-r16 ::= | SEQUENCE { |
| carrierFreq-r16 | ARFCN-ValueEUTRA, |
| measResultList-r16 | MeasResultListEUTRA |

}

| | |
|---|---|
| MeasResultRLFNR-r16 ::= | SEQUENCE { |
| measResult-r16 | SEQUENCE { |
| cellResults-r16 | SEQUENCE { |
| resultsSSB-Cell-r16 | MeasQuantityResults |

OPTIONAL,

| | |
|---|---|
| resultsCSI-RS-Cell-r16 | MeasQuantityResults |

OPTIONAL
},

| | |
|---|---|
| rsIndexResults-r16 | SEQUENCE{ |
| resultsSSB-Indexes-r16 | ResultsPerSSB-IndexList |

OPTIONAL,

| | |
|---|---|
| ssbRLMConfigBitmap-r16 | BIT STRING (SIZE (64)) |

OPTIONAL,

| | |
|---|---|
| resultsCSI-RS-Indexes-r16 | ResultsPerCSI-RS- |

| | |
|---|---|
| IndexList | OPTIONAL, |

| | |
|---|---|
| csi-rsRLMConfigBitmap-r16 | BIT STRING (SIZE (96)) |

```
OPTIONAL
    }
OPTIONAL
  }
}
```

| | |
|---|---|
| MeasResultSuccessHONR-r17 ::= | SEQUENCE { |
| measResult-r17 | SEQUENCE { |
| cellResults-r17 | SEQUENCE { |
| resultsSSB-Cell-r17 | MeasQuantityResults |

OPTIONAL,

| | |
|---|---|
| resultsCSI-RS-Cell-r17 | MeasQuantityResults |

OPTIONAL
},

| | |
|---|---|
| rsIndexResults-r17 | SEQUENCE { |
| resultsSSB-Indexes-r17 | ResultsPerSSB-IndexList |

OPTIONAL,

| | |
|---|---|
| resultsCSI-RS-Indexes-r17 | ResultsPerCSI-RS- |

| | |
|---|---|
| IndexList | OPTIONAL |

```
    }
  }
}
```

The target cell i.e. the one which the UE reestablished to, retrieves the RLF Report E and forwards it to the source cell. Based on the RLF report from the UE and the knowledge about which cell the UE reestablished itself in, the source cell can deduce whether the RLF was caused due to a coverage hole or due to handover/RLM associated parameter configurations.

According to the Rel-17 technical specification of the RRC, a UE generates RLF reports when it experiences a failure of the radio link. RLFs occur due to many different reasons and are therefore triggered by many different events. Therefore, the RLF report contains a large number of information elements, consuming many resources to transmit to the network.

Some of the information sent in the RLF report is only relevant for a minority of the reasons for generating the RLF. Therefore, the RLF report could be made more efficient, i.e., smaller, by only sending this relevant information for the reasons where it is relevant.

Such information is for example the indexes of the Synchronization Signal Block (SSB) beams and the Channel State Information-Reference Signa (CSI-RS) beams, as configured by the network and monitored by the. These indexes are sent in every RLF report, even if they are not relevant for the failure at hand.

Therefore, there is a need to solve, or at least mitigate this issue.

### SUMMARY

An objective is to obviate at least one of the above disadvantages and to improve handling of RLF in a communications system.

According to a first aspect, the objective is achieved by a method performed by a UE for handling Radio Link Failure, RLF, in a communications system. The UE determines that a RLF has occurred. The UE determines whether or not a condition related to the determined RLF is fulfilled. When the condition is fulfilled, the UE generates a RLF report comprising RLM information. The UE provides the RLF report comprising the RLM information to a first network node.

According to a second aspect, the objective is achieved by a method performed by a first network node for handling RLF in a communications system. The first network node obtains an RLF report from the UE. The RLF report comprises RLM information when the condition is fulfilled.

According to a third aspect, the objective is achieved by a UE for handling RLF in a communications system. The UE is arranged to determine that a RLF has occurred. The UE is arranged to determine whether or not a condition related to the determined RLF is fulfilled. The UE is arranged to, when the condition is fulfilled, generate an RLF report comprising RLM information. The UE is arranged to provide the RLF report comprising the RLM information to a first network node.

According to a fourth aspect, the objective is achieved by a first network node for handling RLF in a communications system. The first network node is arranged to obtain a RLF report from the UE. The RLF report comprises RLM information when the condition is fulfilled.

Thanks to the conditional inclusion of the radio link information, handling of RLF in the communications system is improved.

The present disclosure herein affords many advantages, of which a non-exhaustive list of examples follows:

An advantage of the present disclosure is that the RLF report is optimized for size by not including the RLM resource configuration when this information is not relevant for the RLF.

A further advantage of the present disclosure is that it reduces the over the air overhead of transmitting the RLF report.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings in which:

FIG. 1 is a block diagram illustrating ramifications of Self-Configuration/Self-Optimization functionality.

FIG. 2 is a schematic drawing illustrating a communications system.

FIG. 3 is a signaling diagram illustrating a method.

FIG. 4 is a flow chart illustrating a method performed by a UE.

FIG. 5 is a flow chart illustrating a method performed by a network node.

FIG. 6a is a schematic drawing illustrating a UE.

FIG. 6b is a schematic drawing illustrating a UE.

FIG. 7a is a schematic drawing illustrating a network node.

FIG. 7b is a schematic drawing illustrating a network node.

FIG. 8 shows a communication system.

FIG. 9 is a block diagram of a host 900, which may be an embodiment of the host 816 of FIG. 8.

FIG. 10 shows a communication diagram of a host 1002 communicating via a network node 1004 with a UE 1006 over a partially wireless connection.

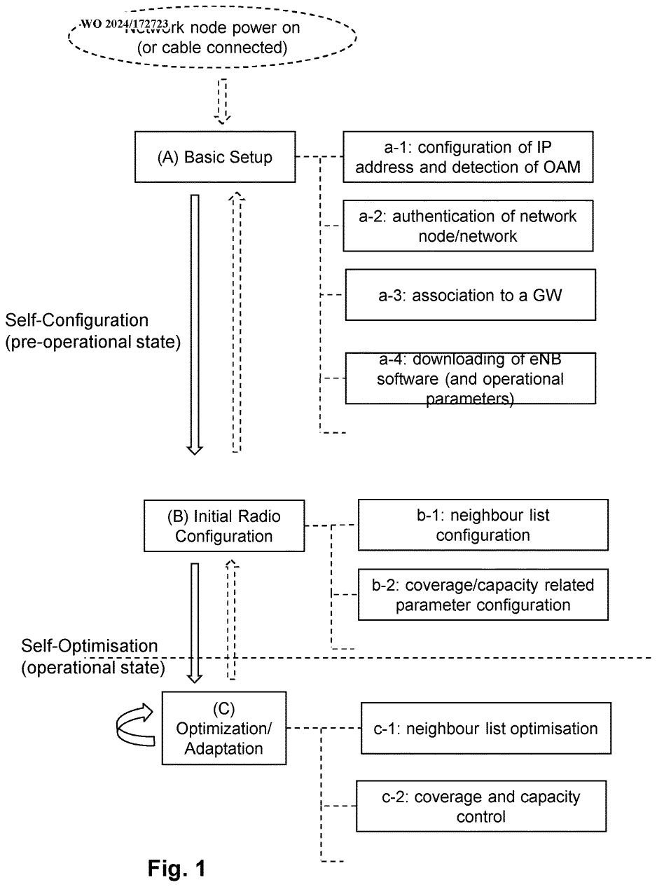

The drawings are not necessarily to scale, and the dimensions of certain features may have been exaggerated for the sake of clarity. Emphasis is instead placed upon illustrating the principle.

### DETAILED DESCRIPTION

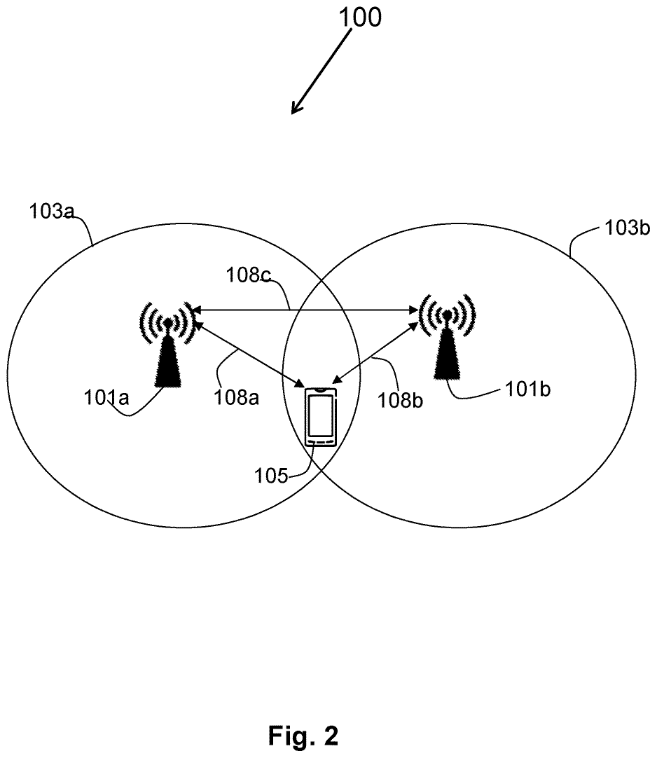

FIG. 2 depicts a non-limiting example of a communications system 100, which may be a wireless communications system, sometimes also referred to as a wireless communications network, cellular radio system, or cellular network, in which the present disclosure may be implemented. The communications system 100 may be a 5G system, 5G network, NR-U or Next Gen system or network. The communications system 100 may alternatively be a younger system or older system than a 5G system, such as e.g., a 2G system, a 3G system, a 4G system, a 6G system a 7G system etc. The communications system 100 may support other technologies such as, for example, Long-Term Evolution (LTE), LTE-Advanced/LTE-Advanced Pro, e.g., LTE Frequency Division Duplex (FDD), LTE Time Division Duplex (TDD), LTE Half-Duplex Frequency Division Duplex (HD-FDD), LTE operating in an unlicensed band, NB-IoT. Thus, although terminology from 5G/NR and LTE may be used in this disclosure to exemplify, this should not be seen as limiting to only the aforementioned systems.

The communications system 100 comprises one or a plurality of network nodes, whereof a first network node 101a and a second network node 101b are depicted in FIG. 2. Any of the first network node 101a, and the second network node 101b may be a radio network node, such as a radio base station, or any other network node with similar features capable of serving a user equipment, such as a wireless device or a machine type communication device, in the communications system 100. The first network node 101a may be an eNB and the second network node 101b may be a gNB. The first network node 101a may be a first eNB, and the second network node 101b may be a second eNB. The first network node 101a may be a first gNB, and the second network node 101b may be a second gNB. The first network node 101a may be a MeNB and the second network node 101b may be a gNB. Any of the first network node 101a and the second network node 101b may be co-localized, or they may be part of the same network node. The first network node 101a may be referred to as a source node or source network node, whereas the second network node 101b may be referred to as a target node or target network node. When the reference number 101 is used herein without the letters a or b, it refers to a network node in general, i.e., it refers to any of the first network node 101a or second network node 101b.

The communications system 100 covers a geographical area which may be divided into cell areas, wherein each cell area may be served by a network node, although, one network node may serve one or several cells. In FIG. 2, the communications system 100 comprises a first cell 103a and a second cell 103b. Note that two cells are exemplified in FIG. 2 only as an example, and that any n number of cells may be comprised in the communication system 100, where n is any positive integer. A cell is a geographical area where radio coverage is provided by the network node at a network node site. Each cell is identified by an identity within the local network node area, which is broadcast in the cell. In FIG. 2, first network node 101a serves the first cell 103a, and the second network node 101b serves the second cell 103b. Any of the first network node 101a and the second network node 101b may be of different classes, such as, e.g., macro base station (BS), home BS or pico BS, based on transmission power and thereby also cell size. Any of the first network node 101a and the second network node 101b may be directly connected to one or more core networks, which are not depicted in FIG. 2 for the sake of simplicity. Any of the first network node 101a and the second network node 101n may be a distributed node, such as a virtual node in the cloud, and it may perform its functions entirely on the cloud, or partially, in collaboration with another network node. The first cell 103a may be referred to as a source cell, whereas the second cell 103b may be referred to as a target cell. When the reference number 103 is used herein without the letters a or b, it refers to a cell in general, i.e., it refers to any of the first cell 103a or second cell 103b.

One or a plurality of UEs 105 is comprised in the communication system 100. Only one UE 105 is exemplified in FIG. 2 for the sake of simplicity. A UE 105 may also be referred to simply as a device. The UE 105, e.g., an LTE UE or a 5G/NR UE, may be a wireless communication device which may also be known as e.g., a wireless device, a mobile terminal, wireless terminal and/or mobile station, a mobile telephone, cellular telephone, or laptop with wireless capability, just to mention some examples. The UE 105 may be a device by which a subscriber may access services offered by an operator's network and services outside operator's network to which the operator's radio access network and core network provide access, e.g., access to the Internet. The UE 105 may be any device, mobile or stationary, enabled to communicate over a radio channel in the communications system 100, for instance but not limited to e.g. UE, mobile phone, smart phone, sensors, meters, vehicles, household appliances, medical appliances, media players, cameras, Machine to Machine (M2M) device, Internet of Things (IoT) device, terminal device, communication device or any type of consumer electronic, for instance but not limited to television, radio, lighting arrangements, tablet computer, laptop or Personal Computer (PC). The UE 105 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in the communications system 100.

The UE 105 is enabled to communicate wirelessly within the communications system 100. The communication may be performed e.g., between two UEs 105, between a UE 105 and a regular telephone, between the UE 105 and a network node, between network nodes, and/or between the UE 105 and a server via the radio access network and possibly one or more core networks and possibly the internet.

The first network node 101a may be configured to communicate in the communications system 100 with the UE 105 over a first communication link 108a, e.g., a radio link. The second network node 101b may be configured to communicate in the communications system 100 with the UE 105 over a second communication link 108b, e.g., a radio link. The first network node 101a may be configured to communicate in the communications system 100 with the second network node 101b over a third communication link 108c, e.g., a radio link or a wired link, although communication over more links may be possible. When the reference number 108 is used herein without the letters a, b or c, it refers to a communication link in general, i.e., it refers to any of the first communication link 108a, the second communication link 108b and the third communication link 108c.

It should be noted that the communication links 108 in the communications system 100 may be of any suitable kind comprising either a wired or wireless link. The link may use any suitable protocol depending on type and level of layer (e.g., as indicated by the Open Systems Interconnection (OSI) model) as understood by the person skilled in the art.

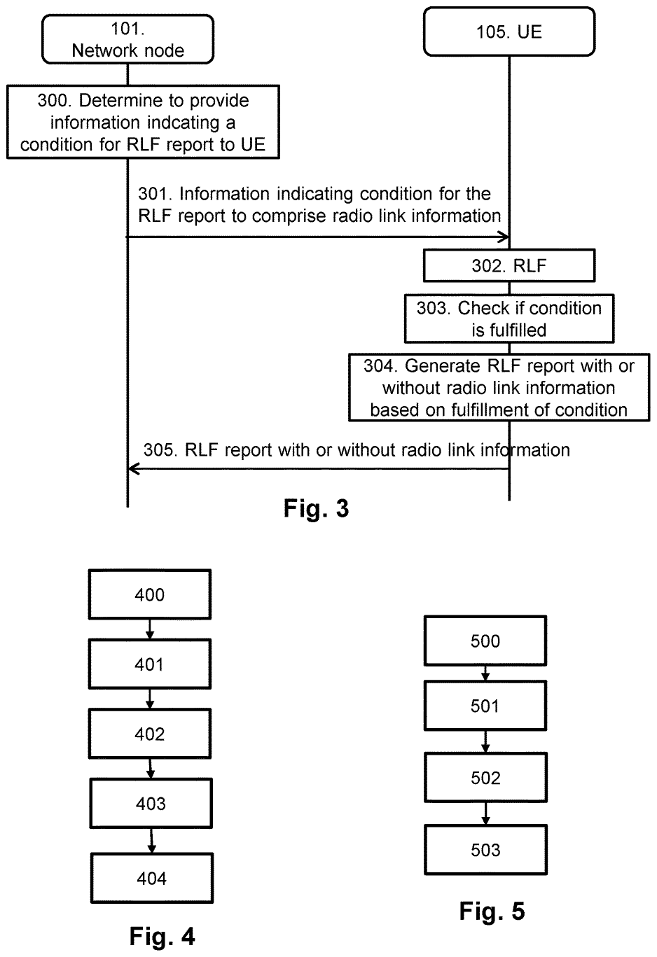

The method for handling RLF in a communication system will now be described with reference to the signaling diagram depicted in FIG. 3. The method comprises the following steps, which steps may as well be carried out in another suitable order than described below.

### Step 300

The UE 105 experiences a radio link failure or determines that a RLF has occurred. Step 300 may be performed at any suitable point before step 302.

### Step 301

The network node 101 may determine to provide information indicating a condition for a RLF report to the UE 105. The condition may be that a radio link procedure leads to an RLF, i.e., that a radio link procedure is the cause of the RLF.

### Step 302

The network node 101 may provide, to the UE, information indicating the condition for the RLF report to comprise radio link information. The UE 105 may receive the information from the network node. In other words, the network node 101 may configure the UE 105 to send RLF information.

### Step 303

The UE 105 checks if a condition related to the RLF is fulfilled. The condition may be that a cause of the RLF was that a RLM procedure has been performed.

### Step 304

The UE 105 generates a RLF report with or without radio link information according to the check made in step 301. The UE 105 generates a RLF report comprising RLM information with the condition is fulfilled.

The RLFL report may comprise RLM information, e.g., indexes of SSB beams and CSI-RS beams. In other words, the radio link information comprises e.g., indexes of SSB beams and CSI-RS beams.

### Step 305

The UE 105 provides a RLF report to the network node 101. The RLF report may comprise RLM formation when the condition is fulfilled. The RLF report does not comprise RLM information when the condition is not fulfilled.

The UE is configured by a network node to generate a Radio Link Failure Report (RLF Report) when certain condition(s) is (are) met, as described above in steps 300 and 301.

There is a conditional inclusion of the RLM resources in the RLF report. The UE 105 logs the RLM resources in the RLF report only if RLM procedure/issue led to the RLF. For example, sub-optimal configuration of the RLM resources may led to start of the T310 timer or the T312 timer. If one of those timers expire, a RLF report can be generated. Therefore, the RLM resources is logged in the RLF report only when timer T310 or timer T312 have expired and caused the generation of the RLF. The conditions may be summarized as follows:
the expiration of the timer T310 led to RLF and to the inclusion of the RLM resources into the RLF report generated by the UE 105.
The expiration of the timer T312 led to RLF and to the inclusion of the RLM resources into the RLF report generated by the UE 105.
The RLM procedure or issue in general led to RLF and to the inclusion of the RLM resources into the RLF report generated by the UE 105.

The UE 105 generates an RLF report excluding RLM information when the RLF is not due to RLM resources and/or procedures.

The network node e.g. a gNB, configures a UE to generate a Radio Link Failure Report (RLF Report) when certain condition(s) is (are) met. The network node configures the UE to log the RLM resources in the RLF report only if RLM procedure/issue led to the RLF. The network node configures a UE to generate an RLF Report excluding RLM information when the RLF is not due to RLM resources and/or procedures.

An example implementation of conditional inclusion of the RLM resources in the RLF report is shown below. The unconditional inclusion of the RLM resources is deleted and replaced with a conditional inclusion of the RLM resources.

An example implementation of the present disclosures will now be described, where the underlined text indicates an example of the present disclosure and which differentiates the present disclosure from the current standard:

### RLF Report Content Determination

The UE 105 shall determine the content in the VarRLF-Report as follows:
1> clear the information included in VarRLF-Report, if any;
1> set the plmn-IdentityList to include the list of EPLMNs stored by the UE 105 (i.e. includes the RPLMN);
1> set the measResultLastServCell to include the cell level RSRP, RSRQ and the available SINR, of the source PCell (in case HO failure) or PCell (in case RLF) based on the available SSB and CSI-RS measurements collected up to the moment the UE detected failure;
1> if the SS/PBCH block-based measurement quantities are available:
   2> set the rsindexResults in measResultLastServCell to include all the available measurement quantities of the source PCell (in case HO failure) or PCell (in case RLF), ordered such that the highest SS/PBCH block RSRP is listed first if SS/PBCH block RSRP measurement results are available, otherwise the highest SS/PBCH block RSRQ is listed first if SS/PBCH block RSRQ measurement results are available, otherwise the highest SS/PBCH block SINR is listed first, based on the available SS/PBCH block based measurements collected up to the moment the UE 105 detected failure;
1> if the CSI-RS based measurement quantities are available:
   2> set the rsindexResults in measResultLastServCell to include all the available measurement quantities of the source PCell (in case HO failure) or PCell (in case RLF), ordered such that the highest CSI-RS RSRP is listed first if CSI-RS RSRP measurement results are available, otherwise the highest CSI-RS RSRQ is listed first if CSI-RS RSRQ measurement results are available, otherwise the highest CSI-RS SINR is listed first, based on the available CSI-RS based measurements collected up to the moment the UE 105 detected failure;
1> for each of the configured measObjectNR in which measurements are available:
   2> if the SS/PBCH block-based measurement quantities are available:
      3> set the measResultListNR in measResultNeighCells to include all the available measurement quantities of the best measured cells, other than the source PCell (in case HO failure) or PCell (in case RLF), ordered such that the cell with highest SS/PBCH block RSRP is listed first if SS/PBCH block RSRP measurement results are available, otherwise the cell with highest SS/PBCH block RSRQ is listed first if SS/PBCH block RSRQ measurement results are available, otherwise the cell 103 with highest SS/PBCH block SINR is listed first, based on the available SS/PBCH block based measurements collected up to the moment the UE 105 detected failure;
         4>for each neighbour cell 103 included, include the optional fields that are available;
NOTE 0a: For the neighboring cells 103 included in measResultListNR in measResultNeighCells ordered based on the SS/PBCH block measurement quantities, UE also includes the CSI-RS based measurement quantities, if available.
   2> if the CSI-RS based measurement quantities are available:
      3> set the measResultListNR in measResultNeighCells to include all the available measurement quantities of the best measured cells, other than the source PCell (in case HO failure) or PCell (in case RLF), ordered such that the cell with highest CSI-RS RSRP is listed first if CSI-RS RSRP measurement results are available, otherwise the cell 103 with highest CSI-RS RSRQ is listed first if CSI-RS RSRQ measurement results are available, otherwise the cell with highest CSI-RS SINR is listed first, based on the available CSI-RS based measurements collected up to the moment the UE 105 detected radio link failure;
         4>for each neighbour cell 103 included, include the optional fields that are available;
NOTE 0b: For ordering the neighboring cells 103 based on the CSI-RS measurement quantities, UE 105 includes measurements only for the cells not yet included in measResultListNR in measResultNeighCells to avoid overriding SS/PBCH block-based ordered measurements.
   2>for each neighbour cell, if any, included in measResultListNR in measResultNeighCells:
      3> if the UE 105 supports RLF-Report for conditional handover and if the neighbour cell is one of the candidate cells for which the reconfigurationWithSync is included in the masterCellGroup in the MCG VarConditionalReconfig at the moment of the detected failure:
         4> set choConfig in MeasResult2NR to the execution condition for each measId within condTriggerConfig associated to the neighbour cell 103 within the MCG VarConditionalReconfig;
         4> if the first entry of choConfig corresponds to a fulfilled execution condition at the moment of HOF, or RLF; or
         4> if the second entry of choConfig, if available, corresponds to a fulfilled execution condition at the moment of HOF, or RLF:
         5> set firstTriggeredEvent to the execution condition condFirstEvent corresponding to the first entry of choConfig or to the execution condition condSecondEvent corresponding to the second entry of choConfig, whichever execution condition was fulfilled first in time;
         5> set timeBetweenEvents to the elapsed time between the point in time of fullfilling the condition in choConfig that was fulfilled first in time, and the point in time of fullfilling the condition in choConfig that was fulfilled second in time, if both the first execution condition corresponding to the first entry and the second execution condition corresponding to the second entry in the choConfig were fullfilled;
1> for each of the configured EUTRA frequencies in which measurements are available;
   2> set the measResultListEUTRA in measResultNeighCells to include the best measured cells ordered such that the cell with highest RSRP is listed first if RSRP measurement results are available, otherwise the cell 103 with highest RSRQ is listed first, and based on measurements collected up to the moment the UE 105 detected failure;
      3>for each neighbour cell 103 included, include the optional fields that are available;
NOTE 1: The measured quantities are filtered by the L3 filter as configured in the mobility measurement configuration. The measurements are based on the time domain measurement resource restriction, if configured. Exclude-listed cells are not required to be reported.
1> set the c-RNTI to the C-RNTI used in the source PCell (in case HO failure) or PCell (in case RLF);
1> if the failure is detected due to reconfiguration with sync failure, set the fields in VarRLF-report as follows:
   2> set the connectionFailure Type to hof,
   2> if the UE 105 supports RLF-Report for DAPS handover and if any DAPS bearer was configured while T304 was running:
      3> set lastHO-Type to daps;
      3> if RLF was detected in the source PCell:
         4> set timeConnSourceDAPS-Failure to the time between the initiation of the DAPS handover execution and the RLF detected in the source PCell while T304 was running;
         4> set the rlf-Cause to the trigger for detecting the source RLF;
   2> if the UE 105 supports RLF-Report for conditional handover and if configuration of the conditional handover is available in the MCG VarConditionalReconfig at the moment of the HOF:
      3> if the UE 105 executed a conditional handover toward target PCell according to the condRRCReconfig of the target PCell:
         4> set timeSinceCHO-Reconfig to the time elapsed between the execution of the last RRCReconfiguration message including reconfigurationWithSync for the target PCell of the failed conditional handover, and the reception in the source PCell of the last conditionalReconfiguration including the condRRCReconfig of the target PCell of the failed conditional handover;
      3> else:
         4> set timeSinceCHO-Reconfig to the time elapsed between the execution of the last RRCReconfiguration message including reconfigurationWithSync for the target PCell of the failed handover, and the reception in the source PCell of the last conditionalReconfiguration including the condRRCReconfig;
      3> set choCandidateCellList to include the global cell identity, if available, and otherwise to the physical cell identity and carrier frequency of each of the candidate target cells 103 for conditional handover included in condRRCReconfig within the MCG VarConditionalReconfig at the time of the failed handover, excluding the candidate target cells 103 included in measResulNeighCells;
   2> if the UE 105 supports RLF-Report for conditional handover and if the last executed RRCReconfiguration message including reconfigurationWithSync was concerning a conditional handover:
      3> set lastHO-Type to cho;
   2> set the nrFailedPCellId in failedPCellId to the global cell identity and tracking area code, if available, and otherwise to the physical cell identity and carrier frequency of the target PCell of the failed handover;
   2> include nrPreviousCell in previousPCellId and set it to the global cell identity and tracking area code of the PCell where the last RRCReconfiguration message including reconfigurationWithSync was received;
   2> set the timeConnFailure to the elapsed time since the execution of the last RRCReconfiguration message including the reconfigurationWithSync;
1> else if the failure is detected due to Mobility from NR failure as described in 5.4.3.5, set the fields in VarRLF-report as follows:
   2> set the connectionFailure Type to hof;
   2> if last MobilityFromNRCommand concerned a failed inter-RAT handover from NR to E-UTRA and if the UE 105 supports RLF Report for Inter-RAT MRO EUTRA (NR to EUTRA):
      3> set the eutraFailedPCellId in failedPCellId to the global cell identity and tracking area code, if available, and otherwise to the physical cell identity and carrier frequency of the target PCell of the failed handover;
   2> include nrPreviousCell in previousPCellId and set it to the global cell identity and tracking area code of the PCell where the last MobilityFromNRCommand message was received;
   2> set the timeConnFailure to the elapsed time since the initialization of the handover associated to the last MobilityFromNRCommand message;
1> else if the failure is detected due to RLF, set the fields in VarRLF-report as follows:
   2> set the connectionFailure Type to rlf,
   2> set the rlf-Cause to the trigger for detecting RLF;
   2> if the rlf-Cause is set to t310Expiry or t312Expiry:
      3> set the ssbRLMConfigBitmap and/or csi-rsRLMConfigBitmap in measResultLastServCell to include the radio link monitoring configuration as configured by the serving cell 103, if available;
   2> set the nrFailedPCellId in failedPCellId to the global cell identity and the tracking area code, if available, and otherwise to the physical cell identity and carrier frequency of the PCell where RLF is detected;
   2> if an RRCReconfiguration message including the reconfigurationWithSync was received before the connection failure:
      3> if the last executed RRCReconfiguration message including the reconfigurationWithSync concerned an intra NR handover and it was received while connected to the previous PCell to which the UE 105 was connected before connecting to the PCell where RLF is detected; and
      3> if the PCell in which the RLF was detected was a result of cell selection and the T311 was not running at the time of PCell selection:
         4> include the nrPreviousCell in previousPCellId and set it to the global cell identity and the tracking area code of the PCell where the last executed RRCReconfiguration message including reconfigurationWithSync was received;
         4> if the last executed RRCReconfiguration message including reconfigurationWithSync was concerning a DAPS handover:
         5> set lastHO-Type to daps;
         4> else if the last executed RRCReconfiguration message including reconfigurationWithSync was concerning a conditional handover:
         5> set lastHO-Type to cho;
         4> set the timeConnFailure to the elapsed time since the execution of the last RRCReconfiguration message including the reconfigurationWithSync;
      3> else if the last RRCReconfiguration message including the reconfigurationWithSync concerned a handover to NR from E-UTRA and if the UE 105 supports RLF Report for Inter-RAT MRO EUTRA:
         4> include the eutraPreviousCell in previousPCellId and set it to the global cell identity and the tracking area code of the E-UTRA PCell where the last RRCReconfiguration message including reconfigurationWithSync was received embedded in E-UTRA RRC message MobilityFromEUTRACommand message;
         4> set the timeConnFailure to the elapsed time since reception of the last RRCReconfiguration message including the reconfigurationWithSync embedded in E-UTRA RRC message MobilityFromEUTRACommand message;
   2> if configuration of the conditional handover is available in the MCG VarConditionalReconfig at the moment of declaring the RLF:
      3> set timeSinceCHO-Reconfig to the time elapsed between the detection of the RLF, and the reception, in the source PCell, of the last conditionalReconfiguration including the condRRCReconfig message;
      3> set choCandidateCellList to include the global cell identity if available, and otherwise to the physical cell identity and carrier frequency of each of all the candidate target cells for conditional handover included in condRRCReconfig within the MCG VarConditionalReconfig at the time of radio link failure, excluding the candidate target cells included in measResulNeighCells;
1> if connectionFailure Type is rlf and the rlf-Cause is set to randomAccessProblem or beamFailureRecoveryFailure; or
1> if connectionFailure Type is hof and if the failed handover is an intra-RAT handover and if rlf-Cause is not set to AbsenseOfDRS;
   2> set the ra-InformationCommon to include the random-access related information;
1> if available, set the locationinfo.

The UE 105 may discard the RLF information or HOF information, i.e. release the UE variable VarRLF-Report, 48 hours after the RLF/HOF is detected.

The term handover failure, abbreviated HFO, may have been used to refer to reconfiguration with sync failure.

The method described above will now be described seen from the perspective of the UE 105. FIG. 4 is a flowchart describing the present method in the UE 105 for handling RLF in a communications system 100. The UE 105 is currently served by the network node 101. The method comprises at least one of the following steps to be performed by the UE, which steps ay be performed in any suitable order than described below:

### Step 400

This step corresponds to step 301 in FIG. 3. The UE may obtain, from the network node, information indicating the condition related to the RLF.

The condition may be that a radio link procedure leads to an RLF.

The condition may be that a RLM procedure leads to an RLF.

The radio link procedure may comprise expiry of a timer, and the expiry of the timer may lead to the RLF.

The timer may be a T310 timer or a T312 timer.

### Step 401

This step corresponds to step 302 in FIG. 3. The UE 105 determines that an RLF has occurred. In other words, the UE 105 detects the occurrence of the RLF.

The RLF may be detected for example
upon T310 expiry in source SpCell; or
upon random access problem indication from source MCG MAC; or
upon indication from source MCG RLC that the maximum number of retransmissions has been reached; or
upon consistent uplink LBT failure indication from source MCG MAC:

The RLF may be a PCell RLF.

The PCell RLF may be detected for example
upon T310 expiry in source PCell; or
upon random access problem indication from source MCG MAC; or
upon indication from source MCG RLC that the maximum number of retransmissions has been reached; or
upon consistent uplink LBT failure indication from source MCG MAC.

### Step 402

This step corresponds to step 303 in FIG. 3. The UE 105 determines whether or not a condition related to the RLF is fulfilled, i.e. the RLF that was determined in step 401.

The condition may be that a RLM procedure leads to the RLF.

The RLM procedure may comprise expiry of a timer, and the expiry of the timer may lead to the RLF.

The timer may be a T310 timer or a T312 timer.

### Step 403

This step corresponds to step 304 in FIG. 3. The UE 105 generates an RLF report. Whether or not the RLF report comprises RLM information is based on the fulfillment of the condition.

When the condition is not fulfilled, the UE 105 may generate a RLF report not comprising RLM information.

When the condition is fulfilled, the UE 105 may generate a RLF report comprising the RLM information.

The RLM information may comprise RLM resource information.

The RLM information may comprise a RLM configuration as configured by the serving cell, the serving network node, or another network node, e.g. a second network node.

### Step 404

This step corresponds to step 305 in FIG. 3. The UE 105 provides the generated RLF report to the network node 101.

The RLF report does not comprise the RLM information when the condition is not fulfilled.

The RLF report comprises the RLM information when the condition is fulfilled.

The RLM information may comprise e.g., indexes of SSB beams and CSI-RS beams.

The RLF report comprises the RLM information only when the condition is fulfilled.

The method described above will now be described seen from the perspective of the network node 101. FIG. 5 is a flowchart describing the present method in the network node 101 for handling RLF in a communications system 100. The network node 101 is currently serving the UE 105. The method comprises at least one of the following steps to be performed by the network node 101, which steps ay be performed in any suitable order than described below:

### Step 500

This step corresponds to step 300 in FIG. 3. The network node may determine to provide information indicating the condition related to the RLF to the UE. In other words, the network node 101 determines to configure the UE 105.

The condition may be that a radio link procedure leads to an RLF.

The condition may be that a RLM procedure leads to an RLF.

The radio link procedure may comprise expiry of a timer, and the expiry of the timer may lead to the RLF.

The timer may be a T310 timer or a T312 timer.

### Step 501

This step corresponds to step 301 in FIG. 3. The network node 101 may provide, to the UE 105, information indicating the condition related to the RLF.

### Step 502

This step corresponds to step 305 in FIG. 3. The network node 101 obtains an RLF report from the UE 105. Whether or not the RLF report comprises RLM information is based on the fulfillment of a condition. The RLF report comprises the RLM information only when the condition is fulfilled.

The RLF report may comprise the RLM information from the UE 105 when the condition is fulfilled.

The RLF report may not comprise the RLM information from the UE 105 when the condition is not fulfilled.

The condition may be that the RLM procedure leads to an RLF.

The condition may be that the RLM procedure leads to an RLF.

The RLM procedure may comprise expiry of a timer, and the expiry of the timer may lead to the RLF.

The timer may be a T310 timer or a T312 timer.

The RLM information may comprise RLM resource information.

The RLM information may comprise a RLM configuration as configured by the serving cell, a serving network node, a another network node, e.g. a second network node.

The radio link information may comprise e.g., indexes of SSB beams and CSI-RS beams.

### Step 503

The network node 101 may act according to the received RLF report.

The network node 101 may act by using the RLF report for any suitable purpose. For example, it may use it in a SON algorithm, together with other RLF reports and other information, to modify/tweak mobility parameters in upcoming UE configurations, for the purpose of reducing further RLFs.

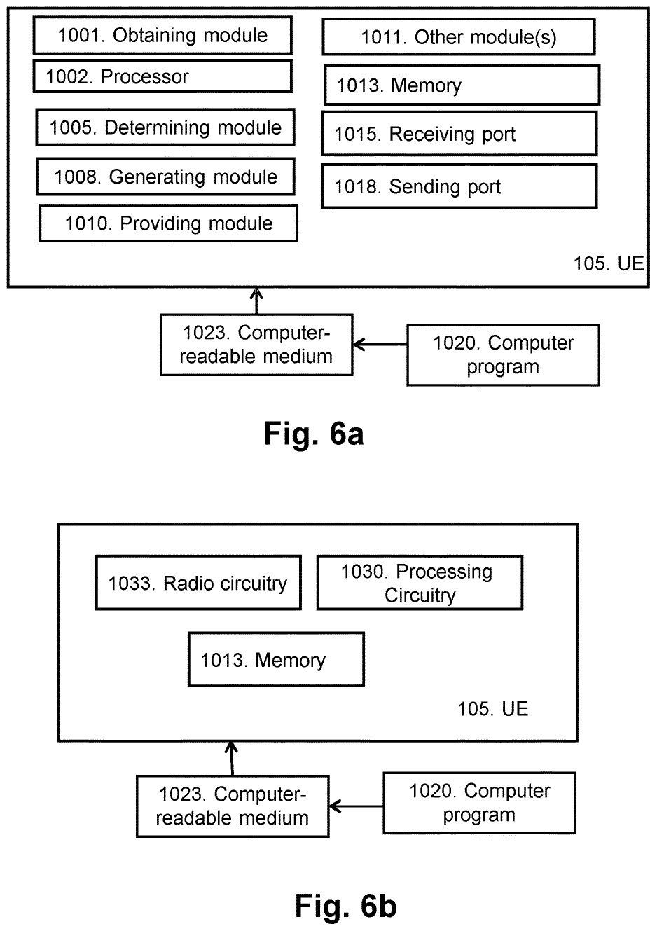

To perform the method steps shown in FIG. 3-4 for handling RLF in a communications system, the UE 105 may comprise an arrangement as shown in FIG. 6a and/or FIG. 6b. FIG. 6a and FIG. 6b depict two different examples in panels a) and b), respectively, of the arrangement that the UE 105 may comprise. The UE 105 may comprise the following arrangement depicted in FIG. 6a.

The UE 105 may be arranged to, e.g., by means of an obtaining module 1001, obtain, from the network node, information indicating the condition related to the RLF. The condition may be that a radio link procedure leads to an RLF. The condition may be that a Radio Link Monitoring, RLM, procedure leads to an RLF. The radio link procedure may comprise expiry of a timer, and the expiry of the timer may lead to the RLF. The timer may be a T310 timer or a T312 timer. The obtaining module 1001 may also be referred to as an obtaining unit, an obtaining means, an obtaining circuit, means for obtaining etc. The obtaining module 1001 may be a processor 1002 of the UE 105 or comprised in the processor 1002 of the UE 105. The obtaining module 1001 may be a receiver, a transceiver etc.

The UE 105 is arranged to, e.g., by means of a determining module 1005, determine that the RLF has occurred and to determine whether or not a condition related to the RLF is fulfilled. The determining module 1005 may also be referred to as a determining unit, a determining means, a determining circuit, means for determining etc. The determining module 1005 may be a processor 1002 of the UE 105 or comprised in the processor 1002 of the UE 105.

The UE 105 is arranged to, e.g., by means of a generating module 1008, generate an RLF report. Whether or not the RLF report comprises RLM information is based on the fulfillment of the condition. The generating module 1008 may also be referred to as a generating unit, a generating means, a generating circuit, means for generating etc. The generating module 1008 may be a processor 1002 of the UE 105 or comprised in the processor 1002 of the UE 105.

When the condition is not fulfilled, the UE 105 may generate a RLF report not comprising RLM information. When the condition is fulfilled, the UE 105 may generate a RLF report comprising RLM information. The RLM information may comprise RLM resource information. The RLM information may comprise a RLM configuration as configured by the serving cell, the serving network node, or the network node 101 or another network node, e.g. the second network node.

The UE 105 is arranged to, e.g., by means of a providing module 1010, provide the generated RLF report to the network node 101. The providing module 1010 may also be referred to as a providing unit, a providing means, a providing circuit, means for providing etc. The providing module 1010 may be a processor 1002 of the UE 105 or comprised in the processor 1002 of the UE 105. The providing module 1010 may be a transmitter, a transceiver etc.

The RLF report may not comprise the RLM information when the condition is not fulfilled. The RLF report may comprise the RLM information when the condition is fulfilled.

The present disclosure related to the UE 105 may be implemented through one or more processors, such as a processor 1002 in the UE 105 depicted in FIG. 6a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the UE 105. One such carrier may be in the form of a CD ROM disc. It is however feasible with other data carriers such as a memory stick. The computer program code may be provided as pure program code on a server and downloaded to the UE 105.

The UE 105 may comprise a memory 1013 comprising one or more memory units. The memory 1013 is arranged to be used to store obtained information, store data, configurations, schedulings, and applications etc. to perform the methods herein when being executed in the UE 105.

The UE 105 may receive information from, e.g., the network node 101, through a receiving port 1015. The receiving port 1015 may be, for example, connected to one or more antennas in UE 105. The UE 105 may receive information from another structure in the communications system 100 through the receiving port 1015. Since the receiving port 1015 may be in communication with the processor 1002, the receiving port 1015 may then send the received information to the processor 1002. The receiving port 1015 may also be configured to receive other information.

The processor 1002 in the UE 105 may be configured to transmit or send information to e.g., network node 101 or another structure in the communications system 100, through a sending port 1018, which may be in communication with the processor 1001, and the memory 1003.

The UE 105 may comprise the obtaining module 1001, the determining module 1005, the generating module 1008, the providing module 1010 and other module(s) 1011. Those skilled in the art will also appreciate that the modules described above may refer to a combination of analogue and digital circuits, and/or one or more processors configured with software and/or firmware, e.g., stored in memory, that, when executed by the one or more processors such as the processor 1002, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

The different modules described above may be implemented as one or more applications running on one or more processors such as the processor 1002.

Thus, the methods described herein for the UE 105 may be respectively implemented by means of a computer program 1020 product, comprising instructions, i.e., software code portions, which, when executed on at least one processor 1002, cause the at least one processor 1002 to carry out the actions described herein, as performed by the UE 105. The computer program 1020 product may be stored on a computer-readable storage medium 1023. The computer-readable storage medium 1023, having stored thereon the computer program 1020, may comprise instructions which, when executed on at least one processor 102, cause the at least one processor 1002 to carry out the actions described herein, as performed by the UE 105. The computer-readable storage medium 1023 may be a non-transitory computer-readable storage medium, such as a CD ROM disc, or a memory stick. The computer program 1020 product may be stored on a carrier containing the computer program 1020 just described, wherein the carrier is one of an electronic signal, optical signal, radio signal, or the first computer-readable storage medium 508, as described above.

The UE 105 may comprise a communication interface configured to facilitate communications between the UE 105 and other nodes or devices, e.g., the network node 101, or another structure. The interface may comprise a transceiver configured to transmit and receive radio signals over an air interface in accordance with a suitable standard.

The UE 105 may comprise the following arrangement depicted in FIG. 6b. The UE 105 may comprise a processing circuitry 1030, e.g., one or more processors such as the processor 1002, in the UE 105 and the memory 1002. The UE 105 may also comprise a radio circuitry 1033, which may comprise e.g., the receiving port 1015 and the sending port 1018. The processing circuitry 1030 may be configured to, or operable to, perform the method actions according to FIG. 3-FIG. 4, in a similar manner as that described in relation to FIG. 6a. The radio circuitry 1033 may be configured to set up and maintain at least a wireless connection with the UE 105. Circuitry may be understood herein as a hardware component.

Hence, the present disclosure also relates to the UE 105 operative to operate in the communications system 100. The UE 105 may comprise the processing circuitry 1030 and the memory 1013. The memory 1013 comprises instructions executable by said processing circuitry 1002. The UE 105 is operative to perform the actions described herein in relation to the UE 105, e.g., in FIGS. 3-4.

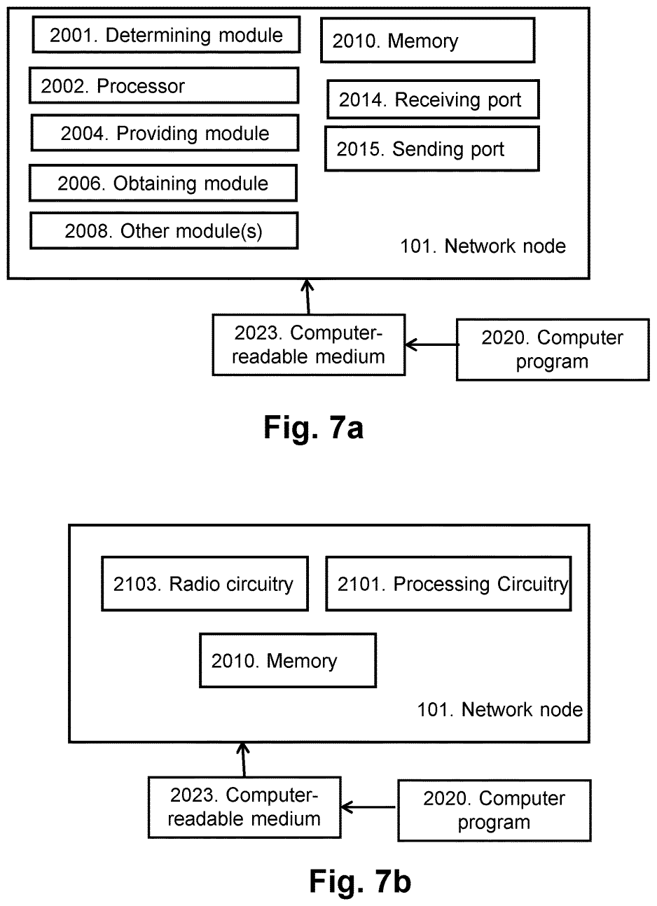

To perform the method steps shown in FIGS. 3 and 5 for handling RLF in a communications system, the network node 101 may comprise an arrangement as shown in FIG. 7a and/or FIG. 7b. FIG. 7a and FIG. 7b depict two different examples in panels a) and b), respectively, of the arrangement that the network node 101 may comprise. The network node 101 may comprise the following arrangement depicted in FIG. 7a. The network node 101 is currently serving the UE 105. The network node 101 may be a source network node which currently serves the UE 105. The network node 101 may be referred to as a serving network node, a source network node, another network node, e.g. a second network node.

The network node 101 may be arranged to, e.g., by means of a determining module 2001, determine to provide information indicating the condition related to the RLF to the UE. The condition may be that a radio link procedure leads to an RLF. The condition may be that a Radio Link Monitoring, RLM, procedure leads to an RLF. The radio link procedure may comprise expiry of a timer, and the expiry of the timer may lead to the RLF. The timer may be a T310 timer or a T312 timer. The determining module 2001 may also be referred to as a determining unit, a determining means, a determining circuit, means for determining etc. The determining module 2001 may be a processor 2002 of the network node or comprised in the processor 2002 of the network node.

The network node 101 may be arranged to, e.g., by means of a providing module 2004, provide, to the UE 105, information indicating the condition related to the RLF. The providing module 2004 may also be referred to as a providing unit, a providing means, a providing circuit, means for providing etc. The providing module 2004 may be a processor 2002 of the network node or comprised in the processor 2002 of the network node. The providing module 2004 may be a transmitter, a transceiver etc.

The network node 101 is arranged to, e.g., by means of an obtaining module 2006, obtain a RLF report from the UE 105. Whether or not the RLF report comprises RLM information is based on the fulfillment of a condition. The obtaining module 2006 may also be referred to as an obtaining unit, an obtaining means, an obtaining circuit, means for obtaining etc. The obtaining module 2006 may be a processor 2002 of the network node or comprised in the processor 2002 of the network node 101. The obtaining module 2004 may be a receiver, a transceiver etc.

The RLF report may comprise the RLM information from the UE 105 when the condition is fulfilled. The RLF report may not comprise the RLM information from the UE 105 when the condition is not fulfilled. The RLM information may comprise RLM resource information. The RLM information may comprise a RLM configuration as configured by the serving cell, the serving network node or another network node, e.g. a second network node.

The network node 101 may be arranged to, e.g. by means of the processor 2002, act according to the received RLF report. The network node 101 may be arranged to act by using the RLF report for any suitable purpose. For example, it may use it in a SON algorithm, together with other RLF reports and other information, to modify/tweak mobility parameters in upcoming UE configurations, for the purpose of reducing further RLFs.

The present disclosure associated with the network node 101 may be implemented through one or more processors, such as a processor 2002 in the network node 101 depicted in FIG. 7a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the network node 101. One such carrier may be in the form of a CD ROM disc. It is however feasible with other data carriers such as a memory stick. The computer program code may be provided as pure program code on a server and downloaded to the network node 101.

The network node 101 may comprise a memory 2010 comprising one or more memory units. The memory 2010 is arranged to be used to store obtained information, store data, configurations, schedulings, and applications etc. to perform the methods herein when being executed in the network node 101.

The network node 101 may receive information from, e.g., the UE 105, through a receiving port 2014. The receiving port 2014 may be, for example, connected to one or more antennas in network node 101. The network node 101 may receive information from another structure in the communications system 100 through the receiving port 2014. Since the receiving port 2014 may be in communication with the processor 2002, the receiving port 2014 may then send the received information to the processor 2002. The receiving port 2014 may also be configured to receive other information.

The processor 2002 in the network node 101 may be configured to transmit or send information to e.g., the UE 105, or another structure in the communications system 100, through a sending port 2015, which may be in communication with the processor 2002, and the memory 2010.

The network node 101 may comprise the determining module 2001, the providing module 2004, the obtaining module 2006 and other module(s) 2008.

Those skilled in the art will also appreciate that the determining module 2001, the providing module 2004, the obtaining module 2006 and other module(s) 2008 described above may refer to a combination of analog and digital circuits, and/or one or more processors configured with software and/or firmware, e.g., stored in memory, that, when executed by the one or more processors such as the processor 2001, perform as described above. One or more of these processors, as well as the other digital hardware, may be comprised in a single ASIC, or several processors and various digital hardware may be distributed among several separate components, whether individually packaged or assembled into a SoC.

Also, the different modules described above may be implemented as one or more applications running on one or more processors such as the processor 2002.

Thus, the methods described herein for the network node 101 may be respectively implemented by means of a computer program 2020 product, comprising instructions, i.e., software code portions, which, when executed on at least one processor 2002, cause the at least one processor 2002 to carry out the actions described herein, as performed by the network node 101. The computer program 2020 product may be stored on a computer-readable storage medium 2023. The computer-readable storage medium 2023, having stored thereon the computer program 2020, may comprise instructions which, when executed on at least one processor 2002, cause the at least one processor 2002 to carry out the actions described herein, as performed by the network node 101. The computer-readable storage medium 2023 may be a non-transitory computer-readable storage medium, such as a CD ROM disc, or a memory stick. The computer program 2020 product may be stored on a carrier containing the computer program 2020 just described, wherein the carrier is one of an electronic signal, optical signal, radio signal, or the second computer-readable storage medium 2023, as described above.

The network node 101 may comprise a communication interface configured to facilitate communications between the network node 101 and other nodes or devices, e.g., the UE 105, or another structure. The interface may, for example, comprise a transceiver configured to transmit and receive radio signals over an air interface in accordance with a suitable standard.

The network node 101 may comprise the following arrangement depicted in FIG. 7b. The network node 101 may comprise a processing circuitry 2101, e.g., one or more processors such as the processor 2002, in the network node 101 and the memory 2010. The network node 101 may also comprise a radio circuitry 2103, which may comprise e.g., the receiving port 2014 and the sending port 2015. The processing circuitry 2101 may be configured to, or operable to, perform the method actions according to FIGS. 3 and 5 in a similar manner as that described in relation to FIG. 7a. The radio circuitry 2103 may be configured to set up and maintain at least a wireless connection with the network node 101. Circuitry may be understood herein as a hardware component.

The network node 101 may be operative to operate in the communications system 100. The network node 101 may comprise the processing circuitry 2101 and the memory 2003. The memory 2010 comprises instructions executable by the processing circuitry 2101. The network node 101 is operative to perform the actions described herein in relation to the network node 101, e.g., in FIGS. 3 and 5.

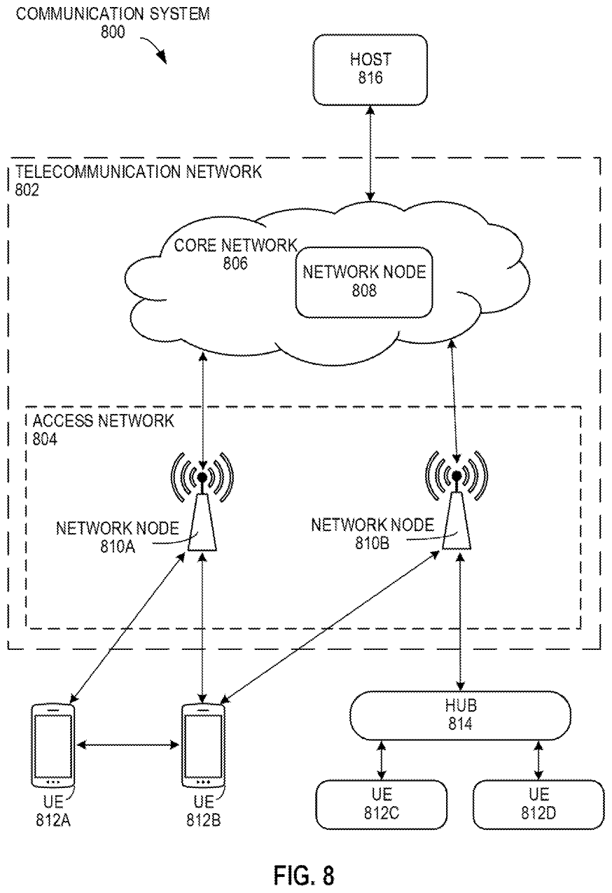

FIG. 8 shows an example of a communication system 800 in accordance with some embodiments.

In the example, the communication system 800 comprises a telecommunication network 802 that comprises an access network 804, such as a radio access network (RAN), and a core network 806, which comprises one or more core network nodes 808. The access network 804 comprises one or more access network nodes, such as network nodes 810a and 810b (one or more of which may be generally referred to as network nodes 810), or any other similar 3rd Generation Partnership Project (3GPP) access node or non-3GPP access point. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection comprise transmitting and/or receiving wireless signals using electromagnetic waves, radio waves, infrared waves, and/or other types of signals suitable for conveying information without the use of wires, cables, or other material conductors. Moreover, in different embodiments, the communication system 800 may comprise any number of wired or wireless networks, network nodes, UEs, and/or any other components or systems that may facilitate or participate in the communication of data and/or signals whether via wired or wireless connections. The communication system 800 may comprise and/or interface with any type of communication, telecommunication, data, cellular, radio network, and/or other similar type of system.

The UEs 812 may be any of a wide variety of communication devices, comprising wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 comprises one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes comprise functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications comprise live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that comprise, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

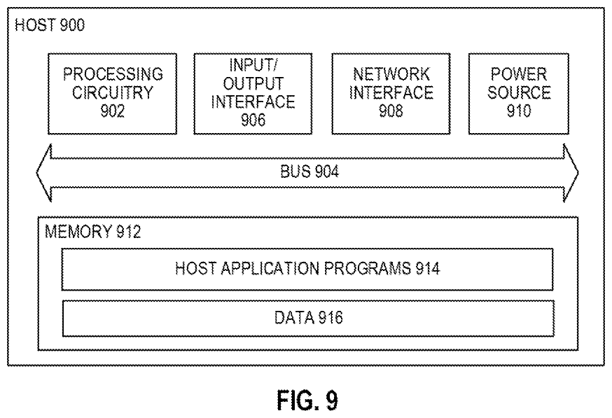

FIG. 9 is a block diagram of a host 900, which may be an embodiment of the host 816 of FIG. 8, in accordance with various aspects described herein. As used herein, the host 900 may be or comprise various combinations hardware and/or software, comprising a standalone server, a blade server, a cloud-implemented server, a distributed server, a virtual machine, container, or processing resources in a server farm. The host 900 may provide one or more services to one or more UEs.

The host 900 comprises processing circuitry 902 that is operatively coupled via a bus 904 to an input/output interface 906, a network interface 908, a power source 910, and a memory 912. Other components may be comprised in other embodiments. Features of these components may be substantially similar to those described with respect to the devices of previous figures, such as FIG. 8, such that the descriptions thereof are generally applicable to the corresponding components of host 900.

The memory 912 may comprise one or more computer programs comprising one or more host application programs 914 and data 916, which may comprise user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), comprising transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

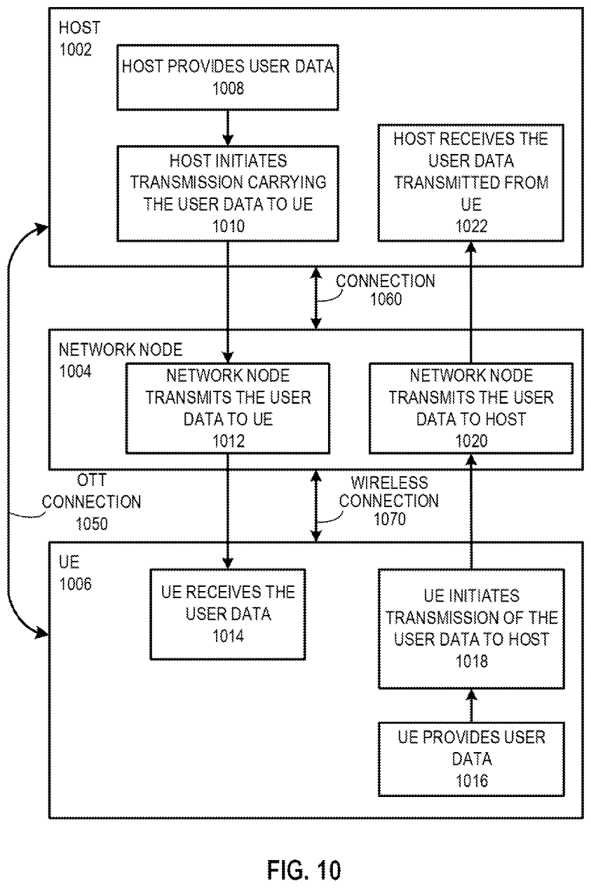

FIG. 10 shows a communication diagram of a host 1002 communicating via a network node 1004 with a UE 1006 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8), and host (such as host 816 of FIG. 8 and/or host 900 of FIG. 9) discussed in the preceding paragraphs will now be described with reference to FIG. 10.

Like host 900, embodiments of host 1002 comprise hardware, such as a communication interface, processing circuitry, and memory. The host 1002 also comprises software, which is stored in or accessible by the host 1002 and executable by the processing circuitry. The software comprises a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 comprises hardware enabling it to communicate with the host 1002 and UE 1006. The connection 1060 may be direct or pass through a core network (like core network 806 of FIG. 8) and/or one or more other intermediate networks, such as one or more public, private, or hosted networks. For example, an intermediate network may be a backbone network or the Internet.

The UE 1006 comprises hardware and software, which is stored in or accessible by UE 1006 and executable by the UE's processing circuitry. The software comprises a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may comprise message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

Summarized, in a RLF report, RLM information, e.g., indexes of SSB beams and CSI-RS beams, are only supplied if they are relevant for the particular triggering condition for the RLF at hand.

The present disclosure optimizes the size of the RLF report by not unnecessarily supplying non relevant information.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The steps of the methods may be performed in another order than the order in which they appear herein.

1.-18. (canceled)

19. A method performed by user equipment (UE) for handling radio link failure (RLF) in a communications system, the method comprising:
determining that an RLF has occurred;
determining whether a condition related to the determined RLF is fulfilled; and
when it is determined that the condition is fulfilled, generating an RLF report comprising radio link monitoring (RLM) information and providing the RLF report comprising the RLM information to a network node.

20. The method according to claim 19, further comprising, when it is determined that the condition is not fulfilled, generating the RLF report without the RLM information and providing the RLF report without the RLM information to the network node.

21. The method according to claim 19, further comprising obtaining, from the network node, information indicating the condition related to the RLF.

22. The method according to claim 19, wherein the condition is that an RLM procedure leads to the RLF.

23. The method according to claim 22, wherein the RLM procedure is based on a timer and the condition is expiry of the timer, which leads to the RLF.

24. The method according to claim 23, wherein the timer is a T310 timer or a T312 timer.

25. The method according to claim 19, wherein the RLM information comprises RLM resource information.

26. The method according to claim 19, wherein the RLM information comprises an RLM configuration provided to the UE by another network node.

27. A method performed by a network node for handling radio link failure (RLF) by user equipment (UE) in a communications system, the method comprising:
obtaining an RLF report from the UE, wherein the RLF report selectively includes radio link monitoring (RLM) information based on whether a condition is fulfilled at the UE.

28. The method according to claim 27, wherein the RLF report includes the RLM information when the condition is fulfilled and the RLF reports excludes the RLM information when the condition is not fulfilled.

29. The method according to claim 27, further comprising providing, to the UE, information indicating the condition related to the RLF.

30. The method according to claim 27, wherein the RLM information comprises one or more of the following: RLM resource information, and an RLM configuration provided to the UE by another network node.

31. User equipment (UE) configured to handle radio Link Failure (RLF) in a communications system, the UE comprising a processor and a memory storing instructions that, when executed by the processor, cause the UE to:
determine that an RLF has occurred;
determine whether a condition related to the determined RLF is fulfilled; and
when it is determined that the condition is fulfilled, generate an RLF report comprising radio link monitoring (RLM) information and provide the RLF report comprising the RLM information to a network node.

32. The UE of claim 31, wherein the memory stores further instructions that, when executed by the processor, cause the UE to generate the RLF report without the RLM information and provide the RLF report without the RLM information to the network node, when it is determined that the condition is not fulfilled.

33. The UE of claim 31, wherein the RLM procedure is based on a timer and the condition is expiry of the timer, which leads to the RLF.

34. The UE of claim 33, wherein the timer is a T310 timer or a T312 timer.

35. The UE of claim 31, wherein the RLM information comprises one or more of the following: RLM resource information, and an RLM configuration provided to the UE by another network node.

36. A network node configured to handle radio link failure (RLF) of user equipment (UEs) in a communications system, the network node comprising a processor and a memory storing instructions that, when executed by the processor, cause the network node to perform the method of claim 27.

37. The network node of claim 36, wherein the RLF report includes the RLM information when the condition is fulfilled and the RLF reports excludes the RLM information when the condition is not fulfilled.

38. The network node of claim 36, wherein the RLM information comprises one or more of the following: RLM resource information, and an RLM configuration provided to the UE by another network node.
